(19) United States
(12) Patent Application Publication
(10) Pub. No.: US 2026/0075537 A1
(43) Pub. Date: Mar. 12, 2026

(54) ACTIVATING UPLINK CARRIER AGGREGATION BASED ON POWER HEADROOM

(71) Applicant: AT&T Intellectual Property I, L.P., Atlanta, GA (US)

(72) Inventors: Jianchun Zhou, Bellevue, WA (US); Yakun Gao, Suwanee, GA (US); Ming Zhang, Bellevue, WA (US)

(21) Appl. No.: 18/884,069

(22) Filed: Sep. 12, 2024

(51) Int. Cl. H04W 52/14; H04W 52/36

(52) U.S. Cl. CPC H04W 52/146; H04W 52/365

(57) ABSTRACT

A method for activating uplink carrier aggregation based on power headroom includes determining a power headroom of a user endpoint device in a cell of a radio access network and determining a number of component carriers to activate for uplink transmissions of the user endpoint device based on the power headroom of the user endpoint device.

The present disclosure relates generally to wireless communications and relates more particularly to devices, non-transitory computer-readable media, and methods for activating uplink carrier aggregation based on power headroom.

### BACKGROUND

Carrier aggregation (CA) is a technique used in wireless communications to increase a user endpoint device's data rate by assigning multiple component carriers (i.e., frequency blocks) to the same user endpoint device, effectively creating a wider channel for data transmissions. The greater the number of component carriers assigned to the user endpoint device, the wider the channel, and, consequently, the greater the increase in the maximum possible data rate the user endpoint device experiences. CA can not only boost the throughput the user endpoint device experiences, but can also reduce the latency.

### SUMMARY

In one example, the present disclosure describes a device, computer-readable medium, and method for activating uplink carrier aggregation based on power headroom. For instance, in one example, a method performed by a processing system including at least one processor includes determining a power headroom of a user endpoint device in a cell of a radio access network and determining a number of component carriers to activate for uplink transmissions of the user endpoint device based on the power headroom of the user endpoint device.

In another example, a non-transitory computer-readable medium stores instructions which, when executed by a processor, cause the processor to perform operations. The operations include determining a power headroom of a user endpoint device in a cell of a radio access network and determining a number of component carriers to activate for uplink transmissions of the user endpoint device based on the power headroom of the user endpoint device.

In another example, a device includes a processor and a computer-readable medium storing instructions which, when executed by the processor, cause the processor to perform operations. The operations include determining a power headroom of a user endpoint device in a cell of a radio access network and determining a number of component carriers to activate for uplink transmissions of the user endpoint device based on the power headroom of the user endpoint device.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for activating uplink carrier aggregation based on power headroom may operate;

FIG. 2 illustrates a flowchart of an example method for activating uplink carrier aggregation based on power headroom, in accordance with the present disclosure;

FIG. 3A illustrates a chart that shows how a number of component carriers activated for uplink transmissions may be increased proportionally with an increase in buffer size;

FIG. 3B illustrates a chart that shows how a number of component carriers activated for uplink transmissions may be increased proportionally with an increase in uplink power headroom; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides devices, non-transitory computer-readable media, and methods for activating uplink carrier aggregation based on power headroom. As discussed above, carrier aggregation (CA) is a technique used in wireless communications to increase a user endpoint device's data rate by assigning multiple component carriers (i.e., frequency blocks) to the same user endpoint device, effectively creating a wider channel for data transmissions. The greater the number of component carriers assigned to the user endpoint device, the wider the channel, and, consequently, the greater the increase in the maximum possible data rate the user endpoint device experiences. CA can not only boost the throughput the user endpoint device experiences, but also can reduce the latency.

CA typically employs a buffer-based approach to activate and deactivate secondary cells (SCells) for both uplink (UL) and downlink (DL) transmissions. In this case, the number of component carriers activated increases with the size of a user endpoint device's buffer. This approach is effective for DL transmissions in which the throughput increases almost linearly with the number of component carriers activated, because the radio access network (RAN) base stations can maintain the same power level across all component carriers. However, increasing the throughput in a similar manner for the UL transmissions is more challenging, particularly when the user endpoint device's power is constrained. For instance, when four component carriers (e.g., 4CC) are activated and the user endpoint device moves toward the edge of a cell, the available power per component carrier is often not enough to maintain a higher order of modulation (e.g., 256 quadrature amplitude modulation, or 256QAM). In this case, the user endpoint device may be forced to use a lower order of modulation (e.g., quadrature phase shift keying, or QPSK) in order to maintain a target block error rate (BLER), resulting in lower spectrum efficiency.

Examples of the present disclosure activate CA for UL transmissions based on the available power of a user endpoint device. In one example, an SCell is activated only when a high (e.g., above a threshold) modulation signal is achievable with the available power of the user endpoint device. In a further example, the SCell may be deactivated when the user endpoint device hits its power ceiling. This power-based approach to activating and deactivating CA for UL transmissions enhances UL spectrum efficiency, throughput, and coverage.

Examples of the present disclosure leverage the fact that the throughput that is achievable using a single component carrier and a higher order of modulation may be equal to (or at least close to) the throughput that is achievable using CA and a lower order of modulation. For instance, as illustrated in Table 1, below, if the available power of a user endpoint device is below a threshold, then the available power can be concentrated in a single component carrier (e.g., 1CC) so that a higher order of modulation (e.g., 256QAM) can be maintained. If four component carriers (e.g., 4CC) are instead activated and a lower order of modulation (e.g., QPSK) is used, the combined throughput of the four component carriers in this case (e.g., 187 Mbps) will be nearly equal to the throughput that is achieved using the single component carrier with the higher order of modulation (e.g., 186 Mbps). Moreover, the spectrum efficiency achieved by the four component carriers and the lower order of modulation is only a fraction (e.g., approximately twenty-five percent) of the spectrum efficiency achieved by the single component carrier and the higher order of modulation.

TABLE 1
UE Throughput as a Function of Modulation
and Number of Carriers

| | |
|---|---|
| FR2, 100 MHz | Buffer-based |

| per Carrier | 256QAM | 64QAM | 16QAM | QSPK |
|---|---|---|---|---|
| 1UE throughput | (8 bits/ | (6 bits/ | (4 bits/ | (2 bits/ |
| (Mbps) | symbol) | symbol) | symbol) | symbol) |
| 1CC | 186 | 140 | 93 | 47 |
| 2CC | 372 | 280 | 187 | 93 |
| 3CC | 559 | 420 | 280 | 140 |
| 4CC | 745 | 560 | 373 | 187 |

According to examples of the present disclosure, the activation and deactivation of UL CA is this based on both buffer fill level and UL power headroom (PHR) of the user endpoint device. Within the context of the present disclosure, power headroom refers to the amount of available or unused power of the user endpoint device, or the difference between the amount of power currently used by the user endpoint device and the user's endpoint device's power ceiling (i.e., maximum available power). Thus, low power headroom indicates that the user endpoint device may be using almost all of its available power, while high power headroom indicates that the user endpoint device may have power to spare.

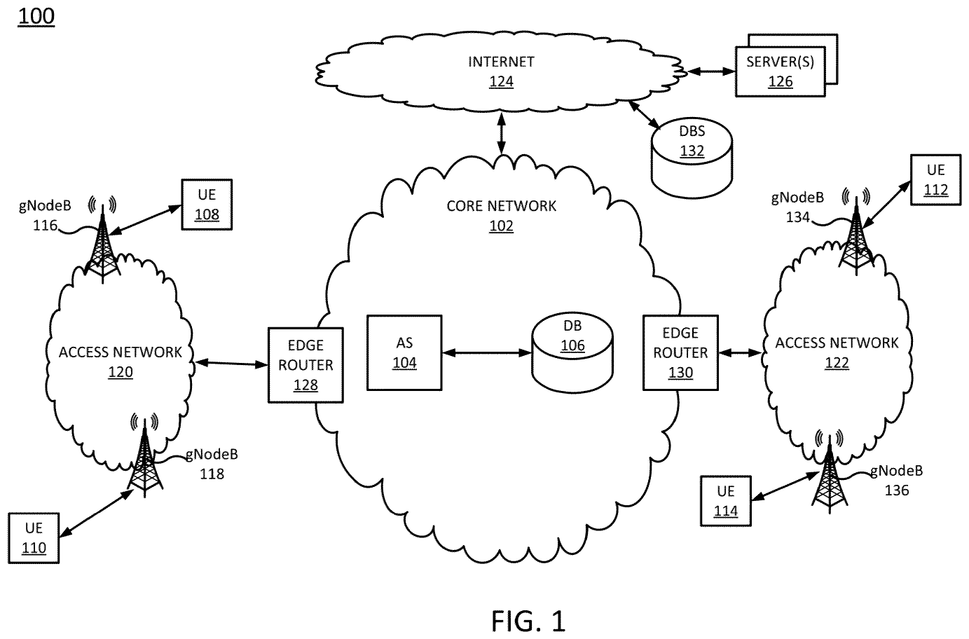

The disclosed approach ensures that SCells are activated only when the user endpoint device has sufficient power to transmit signals of higher order modulation on every carrier. Thus, examples of the present disclosure prioritize maintaining a higher order of modulation over adding SCells for UL transmissions. These and other aspects of the present disclosure are discussed in greater detail in connection with FIGS. 1-4, below.

To further aid in understanding the present disclosure, FIG. 1 illustrates an example system 100 in which examples of the present disclosure for activating uplink carrier aggregation based on power headroom may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, 6G and the like) related to the current disclosure. It should be noted that an IP network is broadly defined as a network that uses Internet Protocol to exchange data packets. Additional example IP networks include Voice over IP (VOIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), mobile cellular access networks, 3^{rd} party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

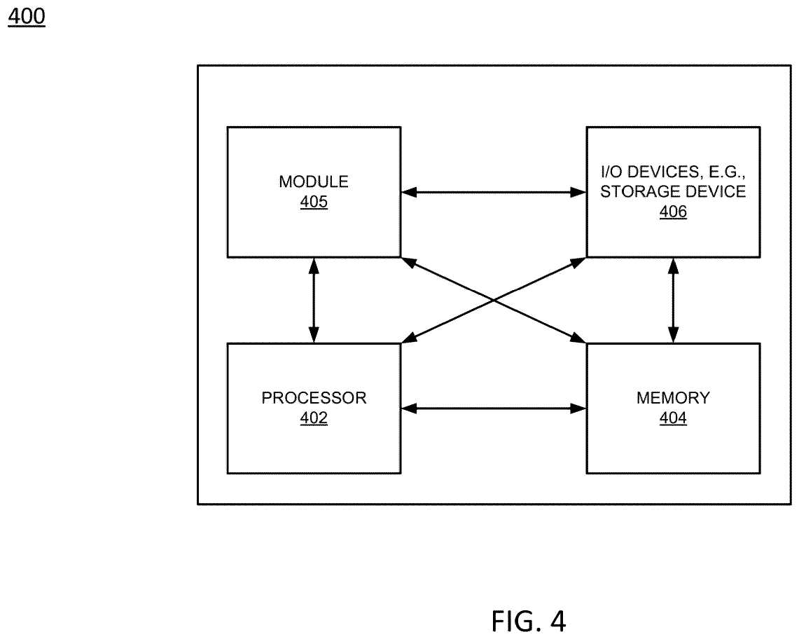

In one example, the access network 120 may be in communication with one or more user endpoint devices 108 and 110. The user endpoint devices 108 and 110 may connect to the access network 120 via one or more base stations (e.g., gNodeBs) 116 and 118. Similarly, the access network 122 may be in communication with one or more user endpoint devices 112 and 114. The user endpoint devices 112 and 114 may connect to the access network 120 via one or more base stations (e.g., gNodeBs) 134 and 136. The access networks 120 and 122 may transmit and receive communications between the user endpoint devices 108, 110, 112, and 114, between the user endpoint devices 108, 110, 112, and 114, the server(s) 126, the AS 104, other components of the core network 102, devices reachable via the Internet in general, and so forth. In one example, each of the user endpoint devices 108, 110, 112, and 114 may comprise any single device or combination of devices that may comprise a user endpoint device, such as computing system 400 depicted in FIG. 4, and may be configured as described below. For example, the user endpoint devices 108, 110, 112, and 114 may each comprise a smart phone, a tablet computer, a laptop computer, a gaming device, a wearable smart device (e.g., a smart watch, smart glasses, a head mounted display, or the like), an IoT device, a connected vehicle, a bank or cluster of such devices, and the like.

In one example, one or more servers 126 and one or more databases 132 may be accessible to user endpoint devices 108, 110, 112, and 114 via Internet 124 in general. The server(s) 126 and DBs 132 may be associated with Internet software applications that may exchange data with the user endpoint devices 108, 110, 112, and 114 over the Internet 124.

In accordance with the present disclosure, one or more of the base stations 116, 118, 134, or 136 may be configured to provide one or more operations or functions in connection with examples of the present disclosure for activating uplink carrier aggregation based on power headroom, as described herein. For instance, in one example, each base station 116, 118, 134, or 136 may monitor a plurality of user endpoint devices (e.g., including user endpoint devices 108, 110, 112, and 114) that are physically present within a cell that is served by each base station 116, 118, 134, or 136. Each base station 116, 118, 134, or 146 may activate and deactivate component carriers (or SCells) for the user endpoint devices' uplink transmissions based at least in part of the power headroom of each of the user endpoint devices (which may be affected by the user endpoint devices' respective distances from the center of the cell served by each base station 116, 118, 134, or 136).

As discussed above, when carrier aggregation is activated for a user endpoint device 108, 110, 112, or 114, the user endpoint device 108, 110, 112, or 114 must split its available power among the carriers that are activated. Thus, the greater the number of carriers that is activated, the lower the amount of the available power that will be allocated to each carrier. If the available power is already very low, splitting that available power among a relatively large number of carriers might force each carrier to downgrade the order of modulation that is used, thereby reducing spectral efficiency.

Thus, according to examples of the present disclosure, a base station 116, 118, 134, or 136 may continuously determine the power headroom for a user endpoint device 108, 110, 112, or 114 that is physically located in a cell that is served by the respective base station 116, 118, 134, or 136 and may continuously adjust the number of carriers activated for uplink transmissions of the user endpoint device 108, 110, 112, or 114 based on the monitored power headroom. In one example, the base station 116, 118, 134, or 136 may compare the power headroom against a plurality of thresholds, where each pair of thresholds of the plurality of thresholds may define a range of available power. Different ranges of available power may be associated with different numbers of activated carriers. For instance, if a lowest threshold is not met, then carrier aggregation may not be activated for the uplink transmissions (e.g., no more than a single carrier may be activated). If a highest threshold is met, then a maximum number of carriers (e.g., four carriers) may be activated for the uplink transmissions. If the lowest threshold it met, but the highest threshold is not met, then a number of carriers between one and the maximum number of carriers (e.g., two or three carriers) may be activated for the uplink transmissions.

As the power headroom for a user endpoint device 108, 110, 112, or 114 changes (e.g., as the user endpoint device 108, 110, 112, or 114 moves away from or closer to the center of the cell that is served by the respective base station 116, 118, 134, or 136), the base station 116, 118, 134, or 136 may increase or decrease the number of carriers that is activated for the uplink transmissions based on which range of available power that the power headroom falls into.

In one example, at least one of the DBs 106 or 132 may store mappings of available power ranges or available power thresholds to numbers of carriers to be activated. These mappings may be defined by an operator of the system 100 in order to optimize spectral efficiency and coverage for uplink transmissions. In one example, the DB 106 may comprise a physical storage device integrated with the AS 104 (e.g., a database server or a file server), or attached or coupled to the AS 104, in accordance with the present disclosure.

The base stations 116, 118, 134, and 136 may comprise one or more physical devices, e.g., one or more computing systems or servers, such as computing system 400 depicted in FIG. 4, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

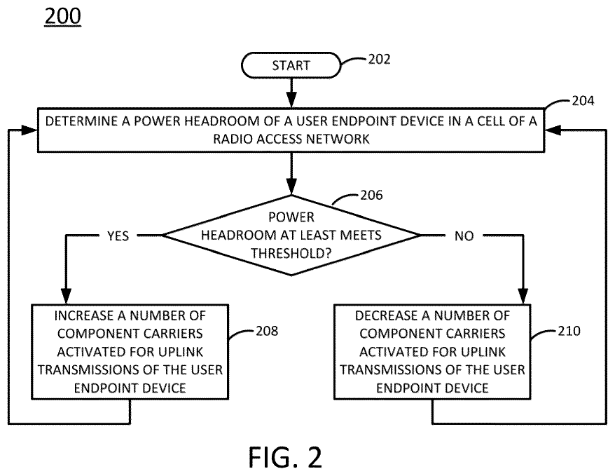

In one example, the base stations 116, 118, 134, and 136 may load instructions into a memory, or one or more distributed memory units, and execute the instructions for activating uplink carrier aggregation based on power headroom, as described herein. For instance, an example method for activating uplink carrier aggregation based on power headroom is discussed in further detail below in connection with FIG. 2.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

To further aid in understanding the present disclosure, FIG. 2 illustrates a flowchart of an example method 200 for activating uplink carrier aggregation based on power headroom, in accordance with the present disclosure. In one example, the method 200 may be performed by a base station of a radio access network, such any of the one or more of the base stations 116, 118, 134, or 136 illustrated in FIG. 1. However, in other examples, the method 200 may be performed by another device, such as an application server (e.g., AS 104 of FIG. 1), a user endpoint device (e.g., any of UEs 108, 110, 112, or 114 of FIG. 1), or the processor 402 of the system 400 illustrated in FIG. 4. For the sake of example, the method 200 is described as being performed by a processing system.

The method 200 begins in step 202. In step 204, the processing system may determine a power headroom of a user endpoint device in a cell of a radio access network.

In one example, the processing system is part of the user endpoint device. The processing system may continuously monitor a power headroom of the user endpoint device while the user endpoint device is connected to the radio access network. As discussed above, when the user endpoint device is physically located closer to the center of the cell, the power headroom may be greater. Conversely, when the user endpoint is physically located further away from the center of the cell (e.g., closer to the cell edge), the power headroom may be lower.

In step 206, the processing system may determine whether the power headroom at least meets a threshold. In one example, the threshold may be measured as a difference in power decibels (ΔdB) between the power ceiling of the user endpoint device and the amount of power currently being used by the user endpoint device. In one example, the threshold may be one of a plurality of thresholds. For instance, a first threshold may be defined as 3 dB, a second threshold may be defined as 6 dB, a third threshold may be defined as 9 dB, and so on.

If the processing system concludes in step 206 that the power headroom at least meets the threshold, then the method 200 may proceed to step 208. In step 208, the processing system may increase a number of component carriers activated for uplink transmissions of the user endpoint device.

In one example, the greater the power headroom, the greater the number of component carriers that the processing system will activate for the uplink transmissions of the user endpoint device. For instance, as discussed above, the threshold may be one of a plurality of thresholds. If the power headroom fails to meet at least a first threshold that is a lowest threshold among the plurality of thresholds (e.g., 3 dB), then the processing system may activate only a single component carrier. However, if the power headroom at least meets the first threshold, but does not at least meet a second threshold that is higher than the first threshold, and may be a second highest threshold among the plurality of thresholds (e.g., 6 dB), then the processing system may increase the number of component carriers activated to up to 2 CC. If the power headroom at least meets the second threshold, but does not at least meet a third threshold that is a highest threshold among the plurality of thresholds (e.g., 9 dB), then the processing system may increase the number of component carriers activated to up to 3 CC. If the power headroom at least meets the third threshold, then the processing system may increase the number of component carriers activated to up to 4 CC.

It should be noted that although the above example makes reference to first, second, and third thresholds for power headroom, any number of thresholds may be used to determine the number of component carriers to activate for the uplink transmissions of the user endpoint device. Moreover, use of terms such as “first,” “second,” and “third” herein is not meant to imply or indicate that a certain number of thresholds exists or is required. Rather, such terms are used merely to differentiate between different thresholds. Thus, for instance, a reference to a “third” threshold is not necessarily meant to imply that “first” and “second” thresholds exist.

Having increased the number of component carriers for uplink transmissions of the user endpoint device, the method 200 may return to step 204, and the processing system may proceed as described above to monitor the power headroom of the user endpoint device and to adjust the number of component carriers for uplink transmissions of the user endpoint device accordingly.

If, however, the processing system concludes in step 206 that the power headroom does not meet the threshold, then the method 200 may proceed to step 210. In step 210, the processing system may decrease (or maintain) a number of component carriers activated for uplink transmissions of the user endpoint device.

As discussed above, in one example, the greater the power headroom, the greater the number of component carriers that the processing system will activate for the uplink transmissions of the user endpoint device. Conversely, the lower the power headroom, the fewer the number of component carriers that the processing system will activate for the uplink transmissions of the user endpoint device.

For instance, as discussed above, the threshold may be one of a plurality of thresholds. If the power headroom at least meets the second threshold (e.g., 6 dB), but does not at least meet the third threshold (e.g., 9 dB), then the processing system may decrease the number of component carriers activated to as few as 3 CC. If the power headroom at least meets the first threshold (e.g., 3 dB), but does not at least meet the second threshold, then the processing system may decrease the number of component carriers activated to as few as 2 CC. If the power headroom fails to meet even the first threshold, then the processing system may decrease the number of component carriers activated to as few as 1 CC (e.g., so that there is no carrier aggregation for uplink transmissions).

Having decreased the number of component carriers for uplink transmissions of the user endpoint device, the method 200 may return to step 204, and the processing system may proceed as described above to monitor the power headroom of the user endpoint device and to adjust the number of component carriers for uplink transmissions of the user endpoint device accordingly.

Thus, the processing system may iterate through the steps of the method 200 for as long as the processing system is powered on and/or connected to the radio access network, or until the processing system receives a signal (e.g., from a user, from a base station of the radio access network, or from another source) to cease operation of the method 200.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

Thus, examples of the present disclosure adjust the number of component carriers allocated to a user endpoint device for uplink transmissions based on the power headroom of the user endpoint device. This approach ensures that SCells are activated only when the user endpoint device has sufficient power to transmit signals of higher order modulation on every carrier. Thus, examples of the present disclosure prioritize maintaining a higher order of modulation over adding SCells for UL transmissions.

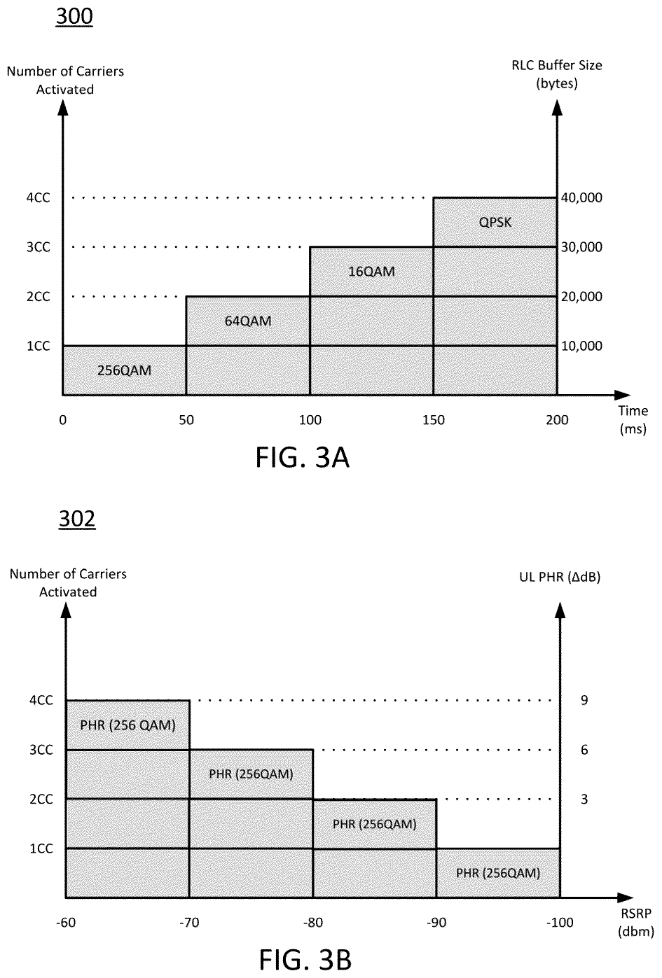

FIGS. 3A and 3B illustrate how the disclosed approach differs from conventional buffer-based approaches for carrier aggregation. In particular, FIG. 3A illustrates a chart 300 that shows how a number of component carriers activated for uplink transmissions may be increased proportionally with an increase in buffer size, while FIG. 3B illustrates a chart 302 that shows how a number of component carriers activated for uplink transmissions may be increased proportionally with an increase in uplink power headroom.

As shown in FIG. 3A, conventional buffer-based carrier aggregation schemes activate a greater number of component carriers for user endpoint devices that have larger buffers. As discussed above, however, this approach does not typically consider power headroom. As a result, even though a user endpoint device may have a relatively large buffer (e.g., 40,000 bytes), if the user endpoint device's power headroom is relatively low, then the user endpoint device will be forced to use a lower order of modulation (e.g., QPSK) due to the available power per carrier. The greater the number of component carriers that are activated in this case, the lower the order of modulation that the user endpoint device will need to use.

By contrast, as shown in FIG. 3B, the present disclosure concentrates limited available power on fewer component carriers so that higher orders of modulation can be maintained. FIG. 3B assumes that at a reference signal received power (RSRP) level of −90 dBm, a user endpoint device can support modulation of 256 QAM with a single component carrier. Thus, as shown in FIG. 3B, as the uplink power headroom decreases, the number of component carriers that is activated also decreases. This allows the user endpoint device to maintain the same order of modulation (e.g., 256 QAM) regardless of the number of component carriers activated, because the available power does not have to be shared among as many component carriers (e.g., the power per carrier may be relatively consistent regardless of the number of component carriers activated).

The approach described in connection with FIG. 2 and illustrated further in FIG. 3B will increase the spectrum efficiency in uplink transmissions for both single-user scenarios and for multiple-user scenarios. For instance, Table 2, below, compares the disclosed power-based carrier aggregations scheme with a conventional buffer-based carrier aggregation scheme for four concurrent user endpoint (UE) devices with an example configuration of TDD pattern 4:1 DL/UL with 100 MHz bandwidth (FR2).

TABLE 2
Cell Throughput (TP) Improvement on 4 UEs (FR2 Example)

| | Buffer-Based | | Power-Based | | | | | |
|---|---|---|---|---|---|---|---|---|
| | CC/ | | CC/ | | 16 | 64 | 256 | |
| 4 UE case | UE | QPSK | UE | QPSK | QAM | QAM | QAM | Gain |
| 1^{st} UE | 4 CC | 47 | 1 CC | 47 | 93 | 140 | 186 | |
| 2^{nd} UE | 4 CC | 47 | 1 CC | 47 | 93 | 140 | 186 | |
| 3^{rd} UE | 4 CC | 47 | 1 CC | 47 | 93 | 140 | 186 | |
| 4^{th} UE | 4 CC | 47 | 1 CC | 47 | 93 | 140 | 186 | |
| Cell TP | | 187 | | 187 | 373 | 560 | 745 | 149% |
| (Mbps) | | | | | | | | |

As shown in Table 2, for buffer-based carrier aggregation activation, each user endpoint device activates four component carriers (4 CC) for carrier aggregation, but is only able to use QPSK modulation on each carrier due to power limitations. However, for power-based carrier aggregation, only a single component carrier (1 CC) is activated for each user endpoint device, which may use QPSK, 16 QAM, 64 QAM, or 256 QAM modulation depending upon radio conditions.

This estimation assumes that most field user cases do not employ full buffers, and that all radio conditions cannot consistently support 256 QAM modulation in uplink transmissions. It is further assumed that each of the four modulation schemes (e.g., QPSK, 16 QAM, 64 QAM, and 256 QAM) is used by an equal number of user endpoint devices. A throughput increase of approximately 149% at the cell level may be achieved using the disclosed power-based approach to activating carrier aggregation.

The disclosed power-based approach may also result in coverage extension by one component carrier versus four component carriers per user endpoint device by 9 dB, thereby increasing at one component carrier for the same QPSK at the cell edge. The coverage could be extended by up to one kilometer from approximately two hundred meters.

FIG. 4 depicts a high-level block diagram of a computing device specifically programmed to perform the functions described herein. For example, any one or more components or devices illustrated in FIG. 1 or described in connection with the method 300 may be implemented as the system 400. For instance, a RAN network base station (such as might be used to perform the method 200) could be implemented as illustrated in FIG. 4.

As depicted in FIG. 4, the system 400 comprises a hardware processor element 402, a memory 404, a module 405 for activating uplink carrier aggregation based on power headroom, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for activating uplink carrier aggregation based on power headroom may include circuitry and/or logic for monitoring power headroom in user endpoint devices and activating and deactivating SCells accordingly. The input/output devices 406 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for activating uplink carrier aggregation based on power headroom (e.g., a software program comprising computer-executable instructions) can be loaded into memory 404 and executed by hardware processor element 402 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for activating uplink carrier aggregation based on power headroom (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
determining, by a processing system including at least one processor, a power headroom of a user endpoint device in a cell of a radio access network; and
determining, by the processing system, a number of component carriers to activate for uplink transmissions of the user endpoint device based on the power headroom of the user endpoint device.

2. The method of claim 1, wherein the processing system is part of a base station of the radio access network that serves the cell.

3. The method of claim 1, wherein the determining the number of component carriers to activate for uplink transmissions of the user endpoint device comprises comparing the power headroom of the user endpoint device to a plurality of thresholds.

4. The method of claim 3, wherein the determining the number of component carriers to activate for the uplink transmissions of the user endpoint device comprises:
determining that the power headroom of the user endpoint device fails to at least meet a first threshold, wherein the first threshold is a lowest threshold among the plurality of thresholds; and
activating a single component carrier for the uplink transmissions of the user endpoint device.

5. The method of claim 3, wherein the determining the number of component carriers to activate for the uplink transmissions of the user endpoint device comprises:
determining that the power headroom of the user endpoint device at least meets a first threshold, wherein the first threshold is a lowest threshold among the plurality of thresholds, but fails to meet a second threshold, wherein the second threshold is higher than the first threshold; and
activating two component carriers for the uplink transmissions of the user endpoint device.

6. The method of claim 3, wherein the determining the number of component carriers to activate for the uplink transmissions of the user endpoint device comprises:
determining that the power headroom of the user endpoint device at least meets a first threshold and a second threshold, wherein the first threshold is a lowest threshold among the plurality of thresholds and the second threshold is a second highest threshold among the plurality of thresholds, but fails to meet a third threshold, wherein the third threshold is a highest threshold among the plurality of thresholds; and
activating three component carriers for the uplink transmissions of the user endpoint device.

7. The method of claim 3, wherein the determining the number of component carriers to activate for the uplink transmissions of the user endpoint device comprises:
determining that the power headroom of the user endpoint device at least meets a third threshold, wherein the third threshold is a highest threshold among the plurality of thresholds; and
activating four component carriers for the uplink transmissions of the user endpoint device.

8. A non-transitory computer-readable medium storing instructions which, when executed by a processing system including at least one processor, cause the processing system to perform operations, the operations comprising:
determining a power headroom of a user endpoint device in a cell of a radio access network; and
determining a number of component carriers to activate for uplink transmissions of the user endpoint device based on the power headroom of the user endpoint device.

9. The non-transitory computer-readable medium of claim 8, wherein the processing system is part of a base station of the radio access network that serves the cell.

10. The non-transitory computer-readable medium of claim 8, wherein the determining the number of component carriers to activate for uplink transmissions of the user endpoint device comprises comparing the power headroom of the user endpoint device to a plurality of thresholds.

11. The non-transitory computer-readable medium of claim 10, wherein the determining the number of component carriers to activate for the uplink transmissions of the user endpoint device comprises:
determining that the power headroom of the user endpoint device fails to at least meet a first threshold, wherein the first threshold is a lowest threshold among the plurality of thresholds; and
activating a single component carrier for the uplink transmissions of the user endpoint device.

12. The non-transitory computer-readable medium of claim 10, wherein the determining the number of component carriers to activate for the uplink transmissions of the user endpoint device comprises:
determining that the power headroom of the user endpoint device at least meets a first threshold, wherein the first threshold is a lowest threshold among the plurality of thresholds, but fails to meet a second threshold, wherein the second threshold is higher than the first threshold; and
activating two component carriers for the uplink transmissions of the user endpoint device.

13. The non-transitory computer-readable medium of claim 10, wherein the determining the number of component carriers to activate for the uplink transmissions of the user endpoint device comprises:
determining that the power headroom of the user endpoint device at least meets a first threshold and a second threshold, wherein the first threshold is a lowest threshold among the plurality of thresholds and the second threshold is a second highest threshold among the plurality of thresholds, but fails to meet a third threshold, wherein the third threshold is a highest threshold among the plurality of thresholds; and
activating three component carriers for the uplink transmissions of the user endpoint device.

14. The non-transitory computer-readable medium of claim 10, wherein the determining the number of component carriers to activate for the uplink transmissions of the user endpoint device comprises:
determining that the power headroom of the user endpoint device at least meets a third threshold, wherein the third threshold is a highest threshold among the plurality of thresholds; and
activating four component carriers for the uplink transmissions of the user endpoint device.

15. A device comprising:
a processing system including at least one processor; and
a computer-readable medium storing instructions which, when executed by the processing system, cause the processing system to perform operations, the operations comprising:
determining a power headroom of a user endpoint device in a cell of a radio access network; and
determining a number of component carriers to activate for uplink transmissions of the user endpoint device based on the power headroom of the user endpoint device.

16. The device of claim 15, wherein the determining the number of component carriers to activate for the uplink transmissions of the user endpoint device comprises comparing the power headroom of the user endpoint device to a plurality of thresholds.

17. The device of claim 16, wherein the determining the number of component carriers to activate for the uplink transmissions of the user endpoint device comprises:
determining that the power headroom of the user endpoint device fails to at least meet a first threshold, wherein the first threshold is a lowest threshold among the plurality of thresholds; and
activating a single component carrier for the uplink transmissions of the user endpoint device.

18. The device of claim 16, wherein the determining the number of component carriers to activate for the uplink transmissions of the user endpoint device comprises:
determining that the power headroom of the user endpoint device at least meets a first threshold, wherein the first threshold is a lowest threshold among the plurality of thresholds, but fails to meet a second threshold, wherein the second threshold is higher than the first threshold; and
activating two component carriers for the uplink transmissions of the user endpoint device.

19. The device of claim 16, wherein the determining the number of component carriers to activate for the uplink transmissions of the user endpoint device comprises:
determining that the power headroom of the user endpoint device at least meets a first threshold and a second threshold, wherein the first threshold is a lowest threshold among the plurality of thresholds and the second threshold is a second highest threshold among the plurality of thresholds, but fails to meet a third threshold, wherein the third threshold is a highest threshold among the plurality of thresholds; and
activating three component carriers for the uplink transmissions of the user endpoint device.

20. The device of claim 16, wherein the determining the number of component carriers to activate for the uplink transmissions of the user endpoint device comprises:
determining that the power headroom of the user endpoint device at least meets a third threshold, wherein the third threshold is a highest threshold among the plurality of thresholds; and
activating four component carriers for the uplink transmissions of the user endpoint device.
